(19) United States
(12) Patent Application Publication
(10) Pub. No.: US 2006/0126905 A1
(43) Pub. Date: Jun. 15, 2006

(54) Method and system for verifying the identity of a user

(76) Inventor: Chee Khin George Loo, Singapore (SG)

Correspondence Address: LAW OFFICES OF ALBERT WAI-KIT CHAN, LLC, WORLD PLAZA, SUITE 604, 141-07 20TH AVENUE, WHITESTONE, NY, 11357, US

(21) Appl. No.: 11/304,171

(22) Filed: Dec. 14, 2005

(30) Foreign Application Priority Data
Dec. 15, 2004 (SG) 200407389-6

(51) Int. Cl. G06K 9/00; G05B 19/00

(52) U.S. Cl. 382/118; 340/5.53

(57) ABSTRACT

A method of verifying the identity of a user as being a user who is registered with a face recognition system includes the step of capturing an image that includes the face of the user. One or more values are extracted from the image, each value being representative of a region in the image. The extracted values are presented to the user. When the extracted values presented to the user correspond to stored values that were provided to the user during a process of registering the user with the system, the user initiates a comparison between the extracted values and the stored values. Matching of the extracted values with the stored values verifies the identity of the user as being registered with the system.

### FIELD OF THE INVENTION

The present invention relates generally to face recognition systems which identify a user by comparing an image of the user's face taken when the user requests authorisation, with facial data stored in the system during a process of registering the user with the system. More particularly, the present invention relates to a face recognition system which reduces the amount of processing power required to recognise a users face.

### BACKGROUND TO THE INVENTION

Passwords and identifications cards have long been employed to moderate access to restricted areas and systems. However, security breaches are relatively common using these types of security devices since passwords can be revealed and identifications cards can be misplaced or stolen resulting in unauthorised persons obtaining access.

The emergence of biometric systems has attempted to address some of the problems inherent in conventional identity verification methods. Biometric systems use physiological characteristics which are unique to an individual to verify a person's identity. Suitable physiological characteristics include fingerprints, hand geometry, iris or retinal patterns, facial features, signatures and speech patterns. Although biometric systems have their own limitations they offer the distinct advantage over conventional security methods, that they are not readily appropriated by unauthorised users.

Facial recognition systems generally employ software that takes a facial image and measures certain-facial characteristics such as the distance between the eyes, the length of the nose, and the angle of the jaw, or the depth of the eye sockets to create a unique “template”. Using the template, the software compares the image with a plurality of human face images stored in the system and produces a score that indicates a measure of similarity between the images.

A particular problem with existing face recognition systems is the difficulty in compensating for changes in conditions such as lighting, face orientation and camera angle. One means of overcoming this difficulty has been to store a series of images for each registered user including all possible variations for lighting, camera angle and face orientation. An example of such a system is described in WO 03/088132. The system described automatically synthesizes a plurality of face prototypes which represent the appearance of the face under various lighting conditions, various expressions and face orientations, and the like. The face prototypes are stored for later analysis and comparison with a captured face image which is to be recognised or verified. Whilst these types of methods ameliorate the difficulties associated with recognising faces under varying conditions, the cost of such systems tends to be high in terms of processing power and memory required.

The provision of face recognition security in portable and/or remote systems requiring localised biometric authentification typically requires the face image to be transmitted over a network to a server for comparison against images stored in a database. Such systems are susceptible to the usual short comings associated with reliance on networks including the difficulty that face recognition is not possible when client-server links are down.

The discussion of the background to the invention included herein is included to explain the context of the invention. This is not to be taken as an admission that any of the materials referred to were published, known or part of the common general knowledge as at the priority date of the claims.

### SUMMARY OF THE INVENTION

According to an aspect of the present invention, there is provided a method of verifying the identity of a user as being a user who is registered with a face recognition system, the method including the following steps:

(a) capturing an image including the face of the user;

(b) extracting one or more values, each value being representative of a region in the image;

(c) presenting the extracted values to the user;

(d) comparing the extracted values with values corresponding to the same region or regions of the image previously stored by the system and provided to the user during a process of registering the user with the system;

wherein the user initiates the comparison when the extracted values presented to the user correspond to the stored values provided to the user during the registration process and wherein matching of the extracted values with the stored values verifies the identity of the user as being registered with the system.

In one particular form of the invention, more than one value is extracted from more than one region of the image and the user is required to match each extracted value with the corresponding stored value one at a time. In an alternative embodiment, more than one value is extracted from more than one region of the image and the user is required to concurrently match each extracted value with the corresponding stored value.

The method may further include the step of issuing the registered user with an encrypted smart card upon completing the registration process, wherein the encrypted smart card stores the one or more values extracted during the registration process which need to be recreated by the user on subsequent presentations to the system in order for the identity of the user as a registered user to be verified. Providing the registered users with an encrypted smart card avoids the need to store the values associated with each registered user within the system.

In one embodiment of the invention, the values correspond to mean colour values of one or more regions of the users face in the image. In another form of the invention, the values correspond to mean brightness values of one or more regions of the users face in the image. In yet another embodiment of the invention, the values correspond to mean grey level values of one or more regions of the users face in the image. It is to be understood that how the values are derived it is not important so long as they are derived in the same manner during the registration and recognition phases to enable an accurate comparison to take place.

The method of the present invention may further include the step of transmitting the image of a user whose identity has been verified as being registered with the system to an auxiliary biometric system. The method of the present invention may be used to provide pre processing of facial image data for an auxiliary biometric system such as a conventional face recognition system to minimise processing time for the auxiliary biometric system.

According to another aspect of the present invention, there is provided a method of verifying the identity of a user as being a user who is registered with a face recognition system, the method including the following steps:

(a) on a first presentation of the user to the face recognition system:
(i) capturing an image including the face of the user;
(ii) extracting one or more values, each value being representative of a region in the image;
(iii) storing the extracted values in storage means associated with the system;
(iv) presenting the extracted values to the user;

(b) on any subsequent presentation of the user to the face recognition system:
(i) capturing an image including the face of the user;
(ii) extracting one or more values, each value being representative of a region in the image;
(iii) presenting the extracted values to the user to assist the user in recreating the stored values;
(iv) comparing the extracted values with the stored values corresponding to the same region or regions of the image;

wherein the user initiates the comparison when the extracted values presented to the user correspond the stored values provided to the user during the registration process and wherein matching of the extracted values with the stored values verifies the identity of the user as being registered with the system.

In one particular form of the invention, more than one value is extracted from more than one region of the image and the user is required to match each extracted value with the corresponding stored value one at a time in an alternative embodiment, more than one value is extracted from more than one region of the image and the user is required to concurrently match each extracted value with the corresponding stored value.

The method may further include the step of issuing the registered user with an encrypted smart card upon completing the registration process, wherein the encrypted smart card stores the one or more values extracted during the registration process which need to be recreated by the user on subsequent presentations to the system in order for the identity of the user as a registered user to be verified.

In one embodiment of the invention, the values correspond to mean colour values of one or more regions of the users face in the image. In another form of the invention, the values correspond to mean brightness values of one or more regions of the users face in the image. In yet another embodiment of the invention, the values correspond to mean grey level values of one or more regions of the users face in the image.

The method of the present invention may further include the step of transmitting the image of a user whose identity has been verified as being registered with the system to an auxiliary biometric system.

According to yet another aspect of the present invention, there is provided a face recognition system for verifying the identity of a user as being a user who is registered with the system, including:

(a) an image capturing device for capturing an image including the face of a user;

(b) an extraction component for extracting one or more values from the image, each value being representative of a region in the image;

(c) storage means for storing the one or more extracted values when the user registers with the system;

(d) a feedback component for providing the extracted values to the user to assist the registered user in recreating the stored values;

(e) a comparator for comparing the stored values with the extracted values, the comparator being invoked by the user when the extracted values presented to the user correspond the stored values provided to the user during the registration process; and

(f) a verification component for verifying the identity of the user as being registered with the system if the extracted values match the stored values.

In one embodiment of the invention, the feedback component includes a display component for providing feedback to the user in visual form. In another embodiment, the feedback component includes an audio component for providing feedback to the user in audio form.

The system may further include a transmission component for transmitting the image of a user whose identity has been verified as being registered with the system to an auxiliary biometric system.

In another embodiment, the storage means includes an encrypted smart card storing the one or more values extracted during the process of registering the user with the system.

It is an advantage of the present invention that the face recognition system provides low memory device that is capable of accurately identifying a user who is registered with the system.

It is another advantage of the present invention, that the face recognition system and method to ameliorate some of the problems inherent in convention face recognition systems by prompting the user to recreate the conditions under which the users face was captured and registered with the face recognition system.

It is yet another advantage of the present invention, to provide a low cost face recognition system which is suitable for localised biometric authentification and is accessible to the home market.

### BRIEF DESCRIPTION OF THE DRAWINGS

The invention will now be described in further detail by reference to the attached drawings illustrating example forms of the invention. It is to be understood that the particularity of the drawings does not supersede the generality of the preceding description of the invention. In the drawings:

FIG. 1 is a schematic drawing of an image of a users face.

FIG. 2 is a flow chart of the process of registering a user with the face recognition system according to an embodiment of the present invention.

FIG. 3 is a schematic drawing of an image of user's face showing three regions which are used to extract facial data values according to an embodiment of the present invention.

FIG. 4 is a flow chart of the process of verifying the identity of a user as being a user who is registered with the face recognition system according to an embodiment of the present invention.

FIG. 5 is a schematic drawing showing the image capturing device and feedback component according to an embodiment of the present invention.

FIG. 6 is a schematic drawing showing the image capturing device and feedback component according to another embodiment of the present invention.

### DETAILED DESCRIPTION

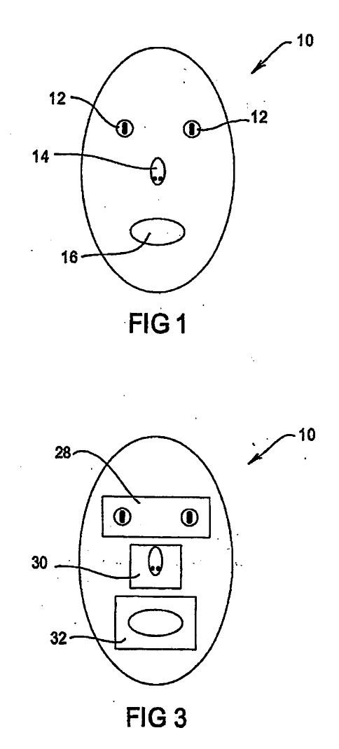

Referring firstly to FIG. 1, the face recognition system of the present invention is adapted to identify and distinguish human faces 10 having two eyes 12, a nose 14 and a mouth 16. Since human facial characteristics are unique to a particular individual they are apt for analysis by security devices which verify and authenticate a persons identity. Unlike many other biometric security systems, systems based on face recognition have the advantage that they do not require any physical contact or effort on the part of the user such as for instance providing a finger print, a retinal scan or a signature.

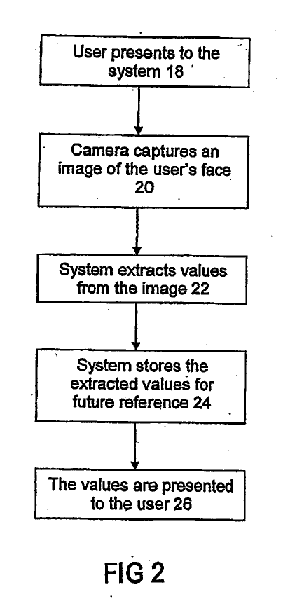

Referring now to FIG. 2, during a process of registration with the face recognition system, a user aligns his or her face 10 with an image capturing device 18 and allows an image including the users face to be captured by a digital camera 20. Other types of image capturing devices suitable for use with the present invention include video cameras, infra-red cameras and the like. One or more values are extracted from the image of the users face 22 and are stored by a suitable storage means 24 such as an integral registered user database or a peripheral storage means such as an encrypted smart card to be carried by the registered user.

Referring now to FIG. 3, each value extracted from the image corresponds to a particular region of the human face 10. As shown in FIG. 3, in one embodiment of the invention, values are extracted from within three regions indicated as a bounding rectangle for the eye region 28, a bounding rectangle for the nose region 30 and a bounding rectangle for the mouth region 32.

The extracted values correspond to a mean value representative of the accumulated charge recorded by the digital camera for the particular region. The mean values may, for example, be derived from the mean colour values of the different regions of the human face, mean brightness values or mean grey level values of one or more regions of the users face in the image. The type of values that the extracted values correspond to is not in itself important so long as the extracted values correspond to the same value type during both the registration phase and the subsequent recognition phase.

Referring again to FIG. 2, once the extracted values have been stored in a suitable storage medium 24, the stored values are presented to the now registered user 26. The registered user is instructed to retain the values in his or her memory to enable the values to be recreated by the user upon any subsequent presentation to the system when access or authorisation is sought by the registered user.

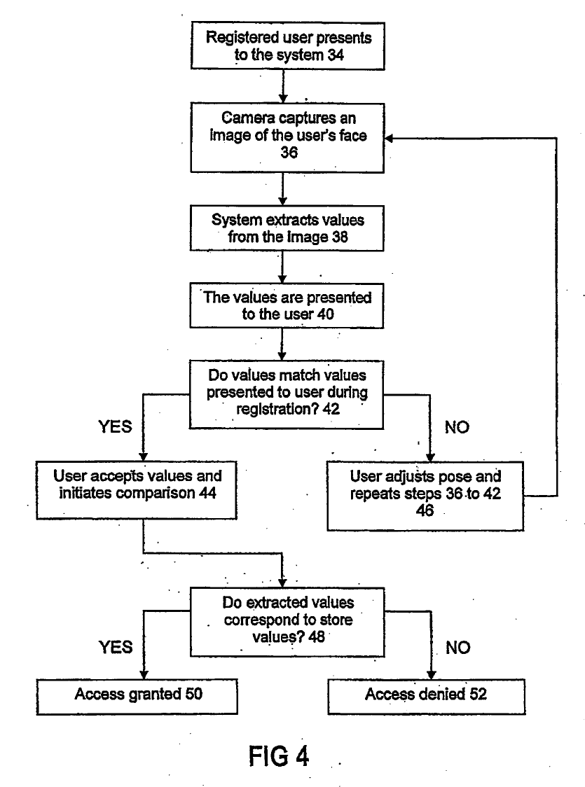

Referring now to FIG. 4, when a registered user presents to the face recognition system for verification as a registered user 34, the registered user must recreate the values stored by the system during the registration phase in order to gain access to the system. During a post registration presentation of the user to the face recognition system, an image including the face of the user is once again captured by the digital camera 36. A predetermined number of values corresponding to the values which were stored during the registration phase are extracted 38 and presented to the user via a feedback component 40. The feedback component may include a display which provides visual feedback to the user, or may include an audio component which provides the user with audio feedback.

If the user recognises the one or more values as corresponding to those which he or she was prompted to remember on registering with the system, the user initiates a comparison by the system of the extracted values with values stored by the system 42 during the registration phase. The user may for example invoke the system s comparator by pressing an ACCEPT button on the control panel. If the extracted values match those stored by the system, then the identity of the user will be verified as a registered user 48 and access or authorisation is granted 50.

If the user does not recognise the one or more values as corresponding to the values which the user has retained in his or her memory from the registration phase, then the user must adjust his or her pose 46, for example to allow more or less light to fall on the users face in an attempt to recreate the values which were stored in the system during the registration phase. The user may have a number of attempts at recreating the stored values so long as the user does not invoke the comparator before the user is confident that the values presented to the user correspond to those stored by the system during the registration phase.

The feedback component of the face recognition system may provide feedback to the user in visual form. The feedback component could, for example, take the form of an LCD display or an LED display. However, it is to be understood that numerous alternative displays types may be suitable, depending on the size and complexity of the system. To maintain security, it is preferable that the visual display not be visible to unauthorised persons. Therefore, it is desirable to have some sort of visual shield associated with the display to ensure only the user whose image has been captured is able to view the values provided by the feedback component. Similarly, where the feedback component provides audio feedback to the user, it is desirable that the audio feedback be transmitted to the user via an earpiece or the like, so that the feedback will not be audible to a passer by.

Referring now to FIG. 5, three values 54, 56, 58 corresponding respectively to a mean charge accumulated by the digital camera within a region of the users face indicated by the bounding rectangle for the eye region 28, the bounding rectangle for the nose region 30 and the bounding rectangle for the mouth region 32 (as shown in FIG. 3) are presented to the user on a visual display 60. The digital camera 62 is positioned directly above the display 60. The extracted values 54, 56, 58 provide the user with an indicator as to how near or far the user is from recreating the values that have were stored in the system during the registration phase.

For the sake of simplicity consider an example where only a single value is extracted from the digital image and a value of 123 is stored during the registration phase or a particular registered user. During a subsequent recognition process, the user is presented with the value 101 which indicates to the user that his or her pose needs to be adjusted to allow more or less light to fall onto his or her face until the value of 123 is recreated. Once the value 123 is presented to the user, the user initiates a comparison by pressing an ACCEPT key on the control panel to signal to the system that the user believes that the displayed value is the value which corresponds to that stored during the registration process.

If the user is not a registered user, but an impostor, he or she will not know that a value of 123 must be recreated to gain access to the system. If the comparator is invoked whilst an incorrect value is presented to the user, the system will take appropriate measures to lock out the impostor such as shutting down the system, sounding an alarm, or the like.

Where only one value is extracted from each image and presented of the user as the “key”, the number of possible values will be relatively small, i.e. 256 possible values. Therefore, depending on the level or security required, it is desirable to increase the number of values extracted to make it more difficult for an impostor to guess the correct values or combination of values which will unlock the system. As the number of values is increased, the level of security of the system increases exponentially. For instance, for three extracted values, there are 2563 (16,777,216) possible value combinations, making it impossible for an impostor to guess the correct value combination to be recreated to gain access to the system. The higher the number of values extracted from each image to be recreated when requesting access, the higher the level of security.

However, by increasing the number of values, it also becomes more difficult for the registered user to recreate the values during the recognition phase. Therefore, a balance needs to be reached between the security level required and the ease of recreating the stored values or “key” for registered users. It is to be understood also that a registered user may require some practice and/or training in order to be proficient at recreating the values during the recognition phase.

Another option for increasing the level of security of the system which is preset, for example, to extract three values, is by requiring that a registered user concurrently match the three values with the stored values by at the same time. It is more difficult for the registered user to recreate two or three values simultaneously, than it is for the registered user to match the same number of values one at a time.

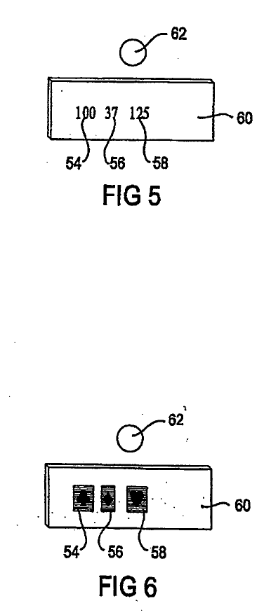

Referring now to FIG. 6, it has been envisaged that due to the difficulty that some individuals may have in remembering a combination of number values to be recreated to gain access to the system, the values or predetermined ranges of values could be represented by appropriate symbols or icons if these are more likely to be remembered by the registered user. Alternatively, to aid in memory of the key, the values could be translated into letters which may be easier for the user to remember. During the registration process, the user may form words which are easy to recall by adjusting his or her face position.

Since it is an essential element of the method disclosed herein that the user remember the values extracted from the image of the users face captured during the registration phase, the face recognition system advantageously provides a minimum of two security factors. For instance, the users unique facial features and skin tones provide a first security factor and the value combination or key provides a second security factor. Even if the user were to reveal his or her key to a non authorised person, it is unlikely that the unauthorised person would be able to recreate the values which would grant him or her access to the system being protected.

In one embodiment, the system includes three levels of security. That is, the face, the key remembered by the user and the encrypted security pass provided to the user which stores the users key. Again even if the key and security pass were provided to an unauthorised person, it is unlikely that the unauthorised person would be able to recreate the values or vectors which would grant him or her access to the system being protected.

A significant advantage of the system of the present invention is that the memory storage capacity required to operate the system is minimal in comparison to existing biometric face recognition systems. This is owing to the fact that it is not necessary to store the images of the faces of registered users, but rather just the one or more extracted values or vectors for each user registered with a system. In one embodiment of the invention, the values are stored in an encrypted smart card to be carried by the registered user. In another embodiment, the values are stored in the localised flash memory of the device for which the face recognition system is moderating access.

It is considered that public acceptance of facial biometric systems could be enhanced if the public were assured that the systems are effective and reliable. The system of the present invention can be guaranteed to be effective if it is used correctly. Responsibility for correct operation of the system lies with the user rather than an unintelligent machine. It is a particular advantage of the system of the present invention that the system does not store any images of the user. This avoids the impact of privacy issues due to security breaches. Finally, unlike existing facial biomatic systems, the key values can be changed if need be. New key values can be provided by a user simply reregistering with the system. This is in contrast to existing systems where an unauthorised person could create a mask of a registered users face to gain access to the system, but the registered user does not have the option of changing his or her face.

The system of the present invention has numerous applications and is particularly suitable for devices such as mobile telephones which have integrated cameras, door security access panels and other devices requiring locallised biometric authentication. In particular, it is envisaged that due to the low cost potential of the system of the present invention, that the system may have particular potential in the home security market.

Finally, it is to be understood that where a higher level of security is required, the system of the present invention can be used as a pre processing system for higher level biometric security devices to cut processing time for transmitting the image of a user whose identity has been verified as being one of a plurality of users registered with the system to an auxiliary face recognition system.

It is to be understood that various additions, alterations and/or modifications may be made to the parts previously described without departing from the ambit of the invention.

The claims defining the invention are as follows:

1. A method of verifying the identity of a user as being a user who is registered with a face recognition system, the method including the following steps:
(a) capturing an image including the face of the user;
(b) extracting one or more values, each value being representative of a region in the image;
(c) presenting the extracted values to the user;
(d) comparing the extracted values with values corresponding to the same region or regions of the image previously stored by the system and provided to the user during a process of registering the user with the system;
wherein the user initiates the comparison when the extracted values presented to the user correspond to the stored values provided to the user during the registration process and wherein matching of the extracted values with the stored values verifies the identity of the user as being registered with the system.

2. A method according to claim 1, wherein more than one value is extracted from more than one region of the image and the user is required to match each extracted value with the corresponding stored value one at a time.

3. A method according to claim 1, wherein more than one value is extracted from more than one region of the image and the user is required to concurrently match each extracted value with the corresponding stored value.

4. A method according to claim 1, further including the step of issuing the registered user with an encrypted smart card upon completing the registration process, wherein the encrypted smart card stores the one or more values extracted during the registration process which need to be recreated by the user on subsequent presentations to the system in order for the identity of the user as a registered user to be verified.

5. A method according to claim 1, wherein each value corresponds to a mean of the colour values detected for a region in the image.

6. A method according to claim 1, wherein each value corresponds to a mean of the brightness values detected for a region of the image.

7. A method according to claim 1, wherein each value corresponds to a mean of the grey level values detected for a region in the image.

8. A method according to claim 1, further including the step of transmitting the image of a user whose identity has been verified as being registered with the system to an auxiliary biometric system.

9. A method of verifying the identity of a user as being a user who is registered with a face recognition system, the method including the following steps:
(a) on a first presentation of the user to the face recognition system:
(i) capturing an image including the face of the user;
(ii) extracting one or more values, each value being representative of a region in the image;
(iii) storing the extracted values in storage means associated with the system;
(iv) presenting the extracted values to the user;
(b) on any subsequent presentation of the user to the face recognition system:
(i) capturing an image including the face of the user;
(ii) extracting one or more values, each value being representative of a region in the image;
(iii) presenting the extracted values to the user to assist the user in recreating the stored values;
(iv) comparing the extracted values with the stored values corresponding to the same region or regions of the image;
wherein the user initiates the comparison when the extracted values presented to the user correspond the stored values provided to the user during the registration process and wherein matching of the extracted values with the stored values verifies the identity of the user as being registered with the system.

10. A method according to claim 9, wherein more than one value is extracted from more than one region of the image and the user is required to match each extracted value with the corresponding stored value one at a time.

11. A method according to claim 9, wherein more than one value is extracted from more than one region of the image and the user is required to concurrently match each extracted value with the corresponding stored value.

12. A method according to claim 9, further including the step of issuing the registered user with an encrypted smart card upon completing the registration process, wherein the encrypted smart card stores the one or more values extracted during the registration process which need to be recreated by the user on subsequent presentations to the system in order for the identity of the user as a registered user to be verified.

13. A method according to claim 9, wherein each value corresponds to a mean of the colour values detected for a region in the image.

14. A method according to claim 9, wherein each value corresponds to a mean of the brightness values detected for a region of the image.

15. A method according to claim 9, wherein each value corresponds to a mean of the grey level values detected for a region in the image.

16. A method according to claim 9, further including the step of transmitting the image of a user whose identity has been verified as being registered with the system to an auxiliary biometric system.

17. A face recognition system for verifying the identity of a user as being a user who is registered with the system, including:
(a) an image capturing device for capturing an image including the face of a user;
(b) an extraction component for extracting one or more values from the image, each value being representative of a region in the image;
(c) storage means for storing the one or more extracted values when the user registers with the system;
(d) a feedback component for providing the extracted values to the user to assist the registered user in recreating the stored values;
(e) a comparator for comparing the stored values with the extracted values, the comparator being invoked by the user when the extracted values presented to the user correspond the stored values provided to the user during the registration process; and
(f) a verification component for verifying the identity of the user as being registered with the system if the extracted values match the stored values.

18. A system according to claim 17, wherein the feedback component includes a display component for providing feedback to the user in visual form.

19. A system according to claim 17, wherein the feedback component includes an audio component for providing feedback to the user in audio form.

20. A system according to claim 17, further including a transmission component for transmitting the image of a user whose identity has been verified as being registered with the system to an auxiliary biometric system.

21. A system according to claim 17, wherein the storage means includes an encrypted smart card storing the one or more values extracted during the process of registering the user with the system.
